(19) United States
(12) Patent Application Publication
(10) Pub. No.: US 2021/0392849 A1
(43) Pub. Date: Dec. 23, 2021

(54) WALL AFFIXED COLLAPSIBLE KENNEL

(71) Applicant: Barbara Stier, Chesterfield, MI (US)

(72) Inventor: Barbara Stier, Chesterfield, MI (US)

(21) Appl. No.: 17/351,895

(22) Filed: Jun. 18, 2021

Related U.S. Application Data
(60) Provisional application No. 63/041,218, filed on Jun. 19, 2020.

(51) Int. Cl. A01K 1/03; A01K 1/01

(52) U.S. Cl. CPC A01K 1/034; A01K 1/0103

(57) ABSTRACT

A collapsible kennel assembly including a plurality of individual and pivotally inter-connected panels, a selected one of the panels adapted to being affixed to a wall and so that the panels are inter-collapsed in succession along first and second sides between an expanded use configuration and a folded storage configuration. Additional features include at least one interior subdividing panel, as well as upper and lower individual pairs of hinges inter-connecting each of the panels. Each of the pairs of hinges including top and bottom hinge components, a circular cross section pin extending from a first hinge component and seating within a recess in the other component for providing swiveling support.

### CROSS REFERENCE TO RELATED APPLICATIONS

The present application claims the priority of U.S. Ser. No. 63/041,218 filed Jun. 19, 2020.

### FIELD OF THE INVENTION

The present invention relates generally to animal kennel enclosures. More specifically, the present invention discloses a wall affixed and collapsible kennel which provides the advantages of maximizing floor space within an installation facility, as well as providing a bottom urine trap for easy removal of stagnant collected urine and without requiring that the kennel door be opened. The present design further provides for ease of scale-ability by adding additional units via a separated panel.

### BACKGROUND OF THE INVENTION

A variety of conventional kennel designs are known in the art which include fixed sides, usually cage or chain link defined. Not known is the provision of any kennel design which can include a panel or partial location affixed to an interior or exterior wall location and which can be converted between expanded use and collapsed storage positions.

### SUMMARY OF THE PRESENT INVENTION

The present invention discloses a collapsible kennel assembly including a plurality of individual and pivotally inter-connected panels, a selected one of the panels adapted to being affixed to a wall. The panels can optionally be provided as an injection molded material and are inter-collapsed in succession along first and second sides between an expanded use configuration and a folded storage configuration.

Additional features include at least one interior subdividing panel, as well as upper and lower individual pairs of hinges inter-connecting each of the panels. Each of the pairs of hinges including top and bottom hinge components, a circular cross section pin extending from a first hinge component and seating within a recess in the other component for providing swiveling support.

The plurality of panels further include a forward door panel having a food and water supporting door at a lower end, this in one non-limiting application being pivotally rotated about a pin to access an inside supporting side thereof. The food and water supporting door further includes a pair of doors individually and pivotally secured to the forward door panel.

Other features include a bottom tray secured between slanted edge locations of opposing panels in order to angle downwardly and forwardly to a front urine collection trap. Additional supports are secured to the food and water panel, which can be folded upwardly to a non-use position during collapsed storage of the assembly.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an assembled perspective of a collapsible kennel enclosure according to one non-limiting variant of the present invention;

FIG. 2 is an overhead plan view of the kennel enclosure of FIG. 1;

FIG. 3 is a succeeding illustration to FIG. 2 and depicting the hinged exterior and interior panels defining the enclosure in a partially collapsed configuration;

FIG. 4 is a further succeeding fully collapsed illustration of the kennel enclosure;

FIG. 4A is a side plan cutaway view of the collapsed kennel enclosure of FIG. 4;

FIG. 5 is an assembled perspective similar to FIG. 1 of kennel enclosure according to a further non-limiting preferred variant and including both the food and water enclosure of FIG. 1 rotated to an internal position within the enclosure, as well as the attachable outer urine collection tray;

FIG. 6 is a cutaway view taken along line 6-6 of FIG. 5 and depicting in phantom the arrangement of the hinged supports associated with each of the outer and inner sub-dividing panels, as well as the optionally removable forward urine collection tray; and

FIG. 7 is an enlarged partial illustration of a forward portion of a collapsible kennel enclosure such as shown in FIG. 6 and depicting the urine collection tray of FIG. 5 which is detachably removable from the forward bottom exterior edge of the enclosure.

### DETAILED DESCRIPTION OF THE PREFERRED EMBODIMENTS

With reference to the appended illustrations, the present invention discloses a wall affixed and collapsible kennel which provides the advantages of maximizing floor space within an installation facility during periods of non-use, as well as providing a bottom urine trap for easy removal of stagnant collected urine and without requiring that the kennel door be opened. As will be further described, the present design provides for ease of scale-ability by adding additional units via a separated panel, and along with a variety of other below described features for more efficiently utilizing a given floor plan of a facility (such as an animal kennel or shelter), and as opposed to utilizing standard fixed cages as is known in the existing art.

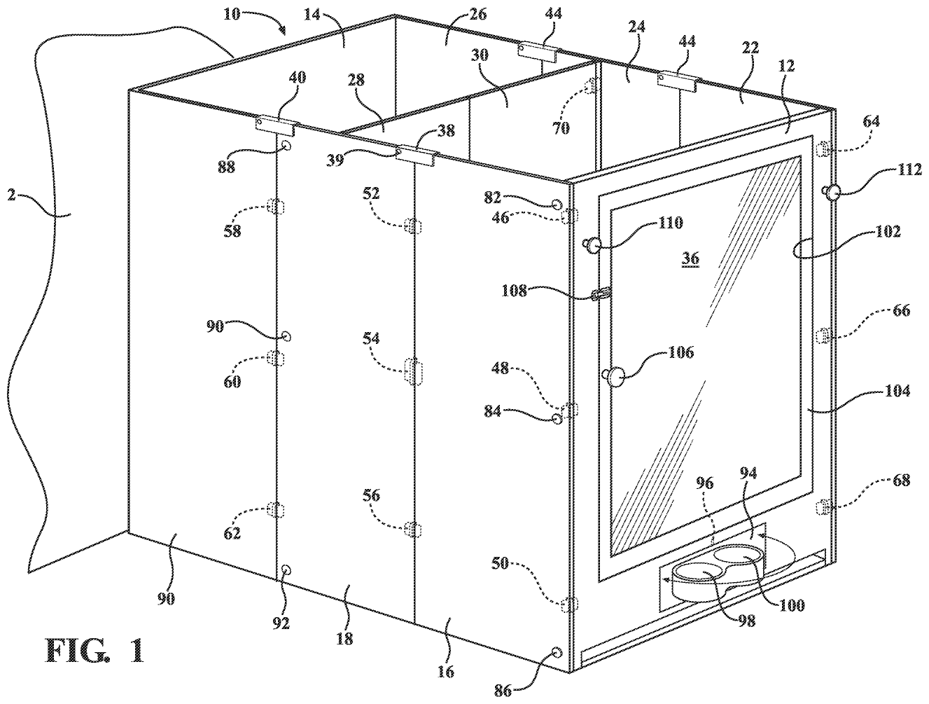

With reference initially to FIG. 1, an assembled perspective of a collapsible kennel enclosure is generally depicted at 10 in a fully open position and according to one non-limiting variant of the present invention. Without limitation, the kennel enclosure 10 can be provided as a stand-alone unit which can be assembled at any location upon an interior or exterior space defining any animal rescue shelter, kennel or other commercial or residential facility.

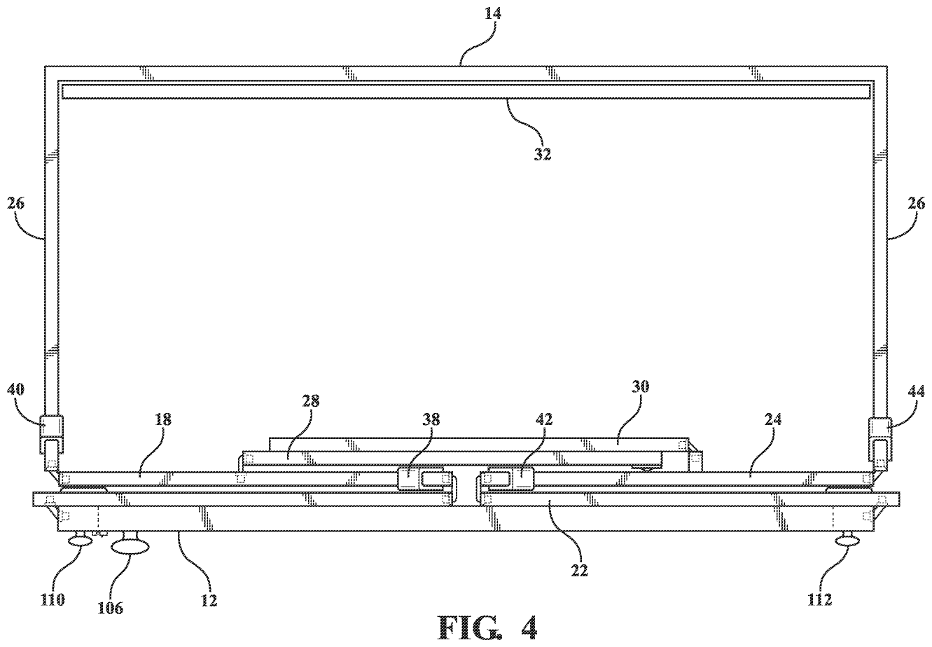

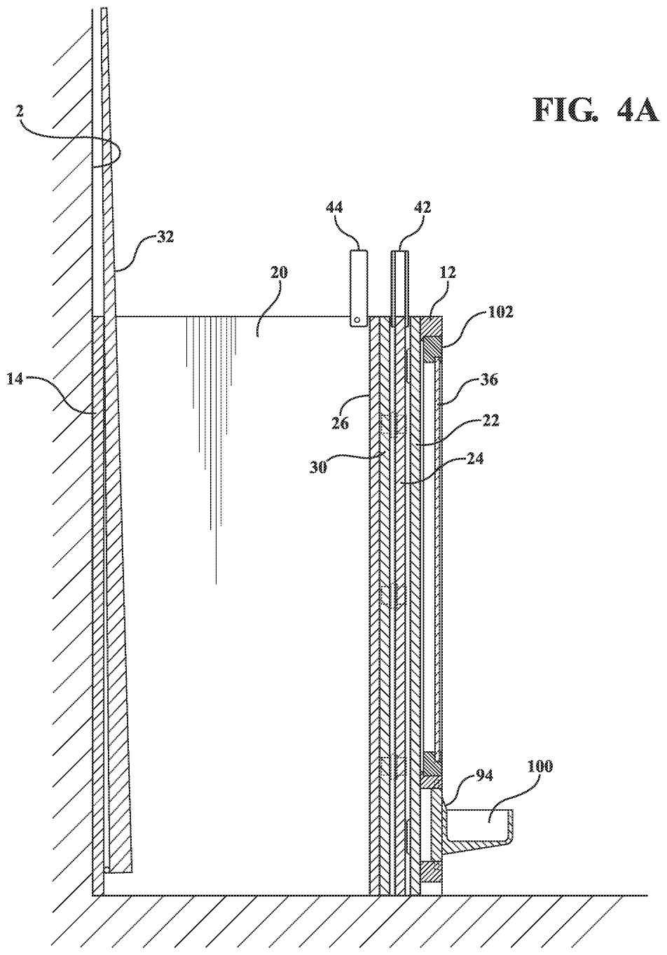

Also shown is a vertical wall or like surface (see at 2) and which, in a preferred application, secures a rear sub-dividing wall of the enclosure. In this manner, the present invention permits the collapsibility of the kennel enclosure (see FIGS. 4-4A) to define a minimal square footage footprint during periods of non-use, this in order to increase the available area within the interior or exterior located facility for other uses and depending upon what level of kennel storage capacity is required. Alternate variants also envision the assembly being portable, such as mounted upon rollers, and which can be easily transported between stored and use positions.

As will be further understood, the various panels and doors of the collapsible assembly can, without limitation, be constructed of any material not limited to a lightweight injection molded plastic, and can be of any desired dimension (length, height and thickness). This can also include, again without limitation, providing the kennel enclosures in varying sizes such as in order to accommodate any of small, medium and larger sized dogs.

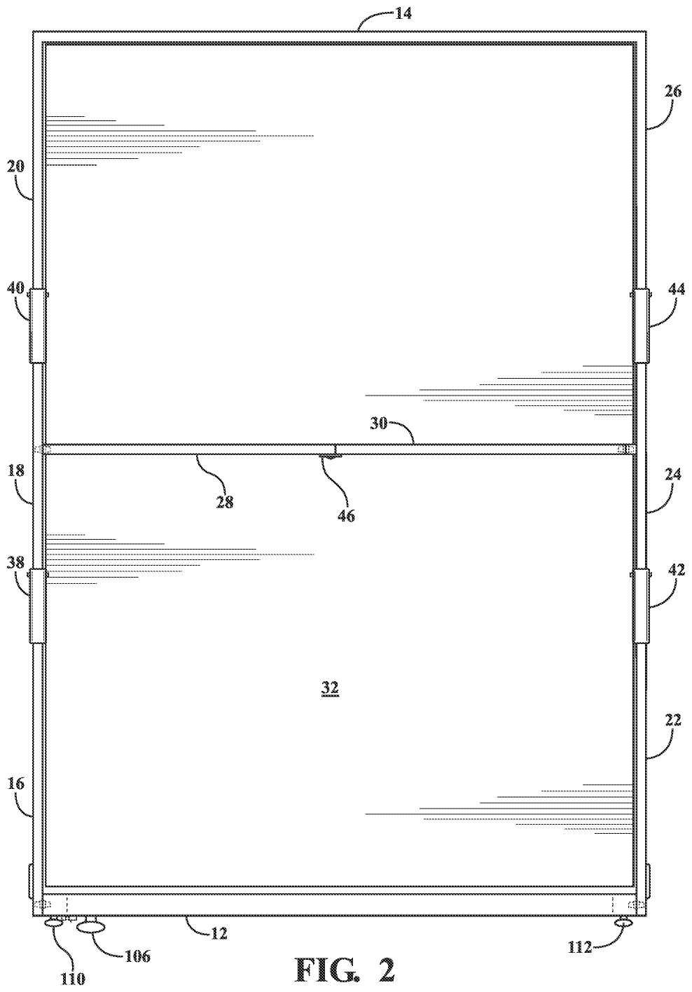

With further reference to succeeding FIGS. 2-7, the assembly includes a plurality of individual panels including each of a front panel 12, a rear panel 14, an interconnecting sub-plurality of first side panels 16, 18 and 20 and an interconnecting sub-plurality of second side panels 22, 24 and 26. An interior of the defined enclosure perimeter can further include interior subdividing or separator doors or additional panels, these shown at 28 and 30 pivotally supported to an inside surface of each of selected interior side panels 18 and 24. Without limitation, a single inside panel or other multiple panel versions can be substituted for that shown and in order to achieve any desired interior subdivided arrangement for the enclosure.

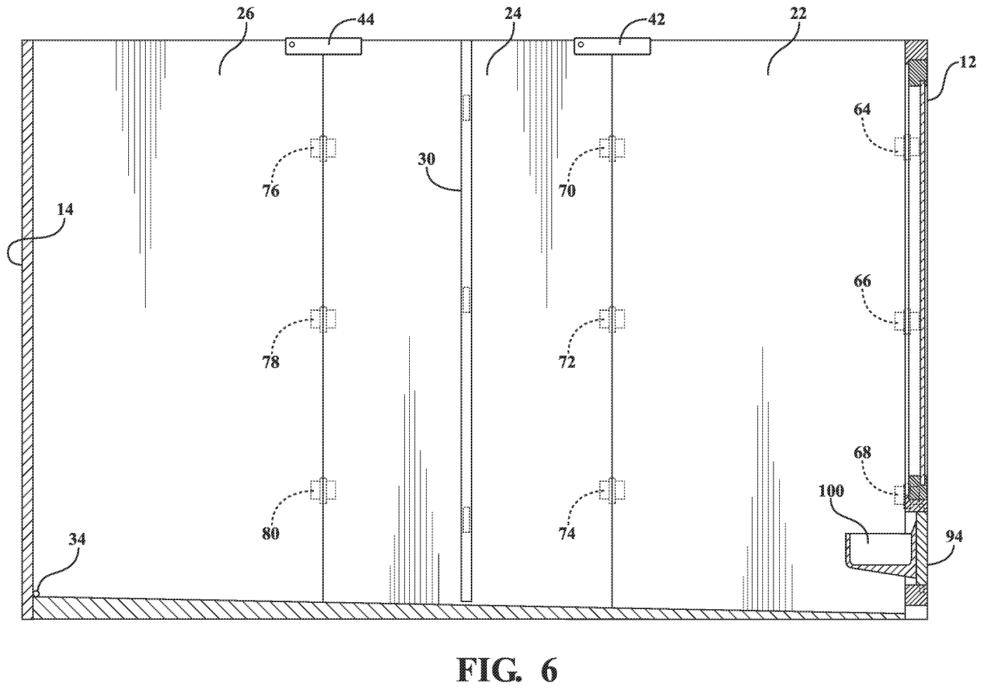

As further best shown in the cutaway view of FIG. 6, a slightly downward/forward angled floor panel 32 is pivotally attached (see as shown by selected one of a plurality of spaced apart hinges at 34) to a bottom interior surface of the rear panel 14. In this fashion, and upon collapsing of the kennel enclosure to the position of FIGS. 4-4A, the floor panel 32 is first upwardly pivoted to rest against (and optionally project upwardly relative to) the rear wall affixed panel 14, following which the remainder of the enclosure 10 is inwardly collapsed towards the rear panel 14 to define a reduced area storage footprint (see again FIGS. 4-4).

As previously indicated, the material construction of the assembly can include, without limitation, any natural or synthetic materials or composites not limited to wood, injection molded plastics, or combinations thereof. In one further non-limiting variant, the frame components or panels 12-32 are constructed of a clear or bronzed anodized aluminum. The door component or panel 12 can additionally or alternatively include a tempered glass covering 36. The various inner and outer wall panels 12-32 can also include fiberglass reinforced plastic isolation panels to resist scratching, staining, odor and moisture. Other materials can include, without limitation, any of Wilsonart® or stainless steel over a polycore (polypropylene fluted core panel construction) for preventing moisture absorption and to retard warpage of the panels in response to changes in ambient temperature.

A series of hinged and locking components are incorporated into the kennel assembly in order to maintain the same between the fully expanded use position of FIGS. 1-2 and the collapsed, non-use position of FIGS. 4-4A. As shown in each of FIGS. 1, 2 and 5, this includes a plurality of “U” channel shaped locking brackets provided for maintaining the first and second sub-pluralities 16-20 and 22-26 of the side panels in the expanded us position. This includes first side “U” bracket 38 pivotally connected (see by selected example of pin shown at 39) between side panels 16 and 18. Additional first side “U” bracket 40 is likewise pivotally connected between side panels 18 and 20. Second side “U” brackets 42 and 44 are, respectively, pivotally connected between second side panels 22/24 and 24/26. As further shown, the “U” brackets 38/40 and 42/44 each pivot between downward engaged positions over the upper opposing edges of the selected side panels 16/18, 18/20, 22/24 and 24/26, as well as upwardly rotated release positions (best depicted by selected “U” brackets 42 and 44 in FIG. 4A) to permit the inward collapsing of the kennel assembly to the reduced area storage position.

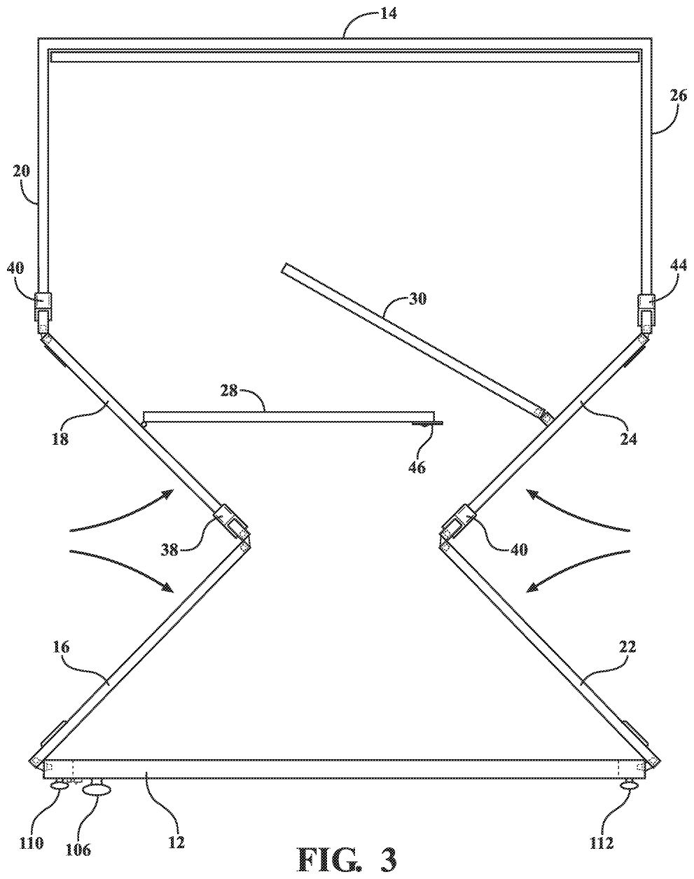

As best shown in FIGS. 2-3, a further interior planar shaped support bracket or plate 46 is shown and which secures the opposing ends of the interior hingedly supported and sub-dividing panels 28 and 30. Any type of latch or like engagement structure can be included which permits the interior bracket 46 to be displaced between use (FIG. 2) and release (FIG. 3) positions to permit the interior panels 28/30 to be collapsed along with the outer perimeter defining panels 12-26 of the kennel assembly.

Pluralities of hinge and pin connections are also provided at each outer front and side perimeter defining panel edge interconnection, with the exception of the rear panel 14 and proximate side panels 20 and 26 which are fixed. Viewing the several illustrations collectively, and as best again shown in FIG. 2, any plurality of individual and vertically spaced apart hinge connections are provided and can include (without limitation) such as three tiered hinge connections along each inter-pivoting panel interface. This includes (as shown in phantom in FIG. 1) an individual sub-plurality of vertically spaced hinges 46, 48, 50 establishing a pivoting interface established between front panel 12 and side panel 16, another sub-plurality of vertically spaced hinges 52, 54 and 56 establishing a pivoting interface between panels 18 and 20, and a further sub-plurality of likewise vertically spaced hinges 58, 60 and 62 establishing a still further pivoting interface between side panels 18 and 20.

An identical arrangement of second side hinges are also provided between the front panel 12 and second side interconnected panels 22, 24 and 26 and, as best shown in the cutaway view of FIG. 6, includes vertically spaced hinges 64, 66 and 68 defining a second side interface between front panel 12 and interconnected side panel 22. Additional sub-pluralities of hinges are shown at each of 70, 72 and 74 defining a pivoting interface between panels 22/24, as well as at 76, 78 and 80 defining a pivoting interface between panels 24/26.

Without limitation, each hinge sub-assembly can include (in one non-limiting application) a pair of angled and offset brackets secured to opposing inside surfaces of the interconnecting panels, with a support pin extending from a selected bracket and through a receiving interior aperture of an opposing and offset arrayed bracket for pivotally and hingedly supporting the panels. Other alternate hinge variants are also assumed for interconnecting the sides and interior panels of the collapsible kennel assembly.

The present invention also contemplates, without limitation, the use of a magnetic locking system configured at each pivot hinge for holding the interconnecting panels in either of the open or closed positions. The magnetic locations are depicted at 82, 84 and 86 (FIG. 1) between front panel 12 and first side panel 16, as well as at 88, 90 and 92 between intermediate first side panel 18 and inner sub-dividing and hingedly supported panel 28. Although not clearly shown, an identical arrangement of magnetic connections are disposed in mirrored fashion along the second side of the collapsible enclosure and also include magnetically inter-attracted pairs of magnets (e.g. positive to negative) located on opposing surfaces of the panels when assembled and which attract each other in the expanded use configuration of FIG. 1 to assist in maintaining the integrity of the assembly.

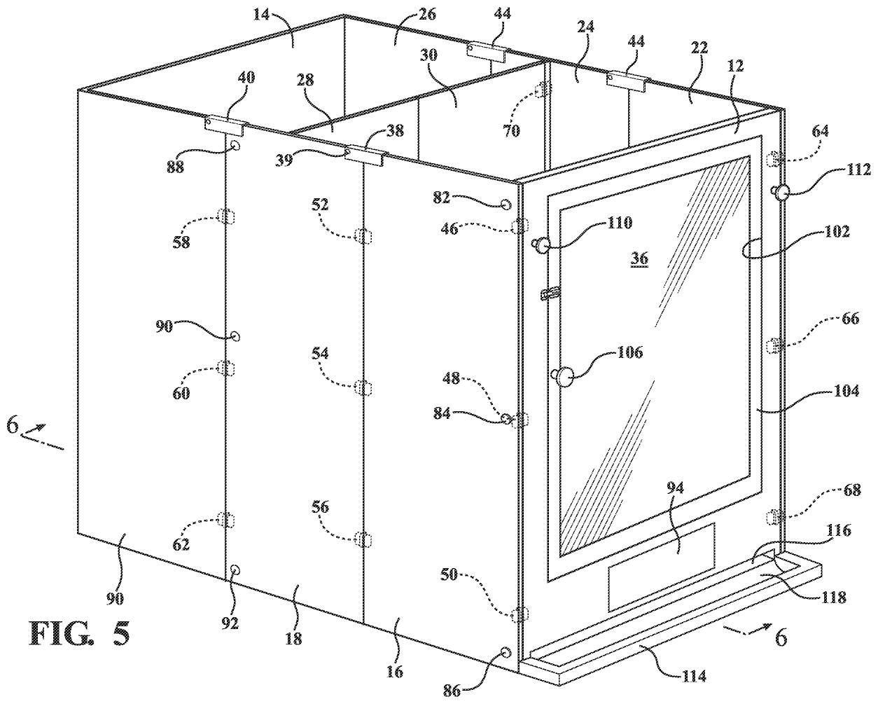

With further reference to each of FIGS. 1, 6 and 7, the front door 12 of the assembly further depicts a pivotally supported food and water door component 94 which can be rotatably supported by a pin (see in phantom at 96 in FIG. 1) for rotating the door component 94 to realign food and water support containers (these shown at 98 and 100 which can be either integrated into the rotating component or include individual lift-out portions) between interior (FIGS. 5-7) and exterior (FIG. 1) locations of the kennel enclosure 10, this further providing the ability to refill the containers without having enter the interior of the kennel enclosure. A suitable latch or slide plate (not shown) can be provided to secure the food and water containers in place when rotated to the interior of the enclosure.

The front door or panel 12 can also include an opening (see inner defining rim 102 in FIGS. 1, 2 and 4) which can support an inner door 104, such in turn supporting the window interior 36 or, alternatively, an openable screen (not shown) for permitting ingress and egress of the animals (such as including but not limited to canines) held within the kennel enclosure in its expanded configuration. A knob 106 is incorporated into the inner door 104 and, in combination with a separate forward latch 108, allows for selective opening and closing of the front facing inner door 102.

In operation, and upon first upwardly pivoting the floor 32 against the inside of the rear fixed panel 14, the pairs of “U” brackets 38/40 and 42/44 are upwardly displaced (see again FIG. 4A). At this point, a pair of hinge linkage actuating knobs 110 and 112 (which are located toward upper edge corners of the front outer panel 12) are actuated, such as by pushing inwardly, and in order to begin collapsing the kennel assembly as shown in FIG. 3, and until it reaches is collapsed configuration as shown in FIGS. 4 and 4A. Without limitation, the hinged connections established between the forward door panel 12 and the forward-most side panels 16 and 22 can include any type of linkage or connection scheme initiating collapsing (or re-expansion) of the individual panels by gripping the outer actuating knobs 110/112.

As previously described, the present design also makes possible adding additional pets to a subdivided interior of the kennel by rotating the opposite side supported inner panels 28 and 30 to the position shown in FIGS. 2 and 5 and engaging the inner latch 46. As also previously indicated, and without limitation, the collapsible kennel can include a variety of individual unit sizes which can include such as five and a half foot in height, thirty two feet in length and four feet in depth. Accordingly, the representations of the kennels depicted are understood to be general in nature and that any given configuration is envisioned to maximize the efficiency of a given floor plan layout. In such a layout, a plurality of individual doors (see again at 102) can be configured into a forward facing side of the unit in a further subdivided variant.

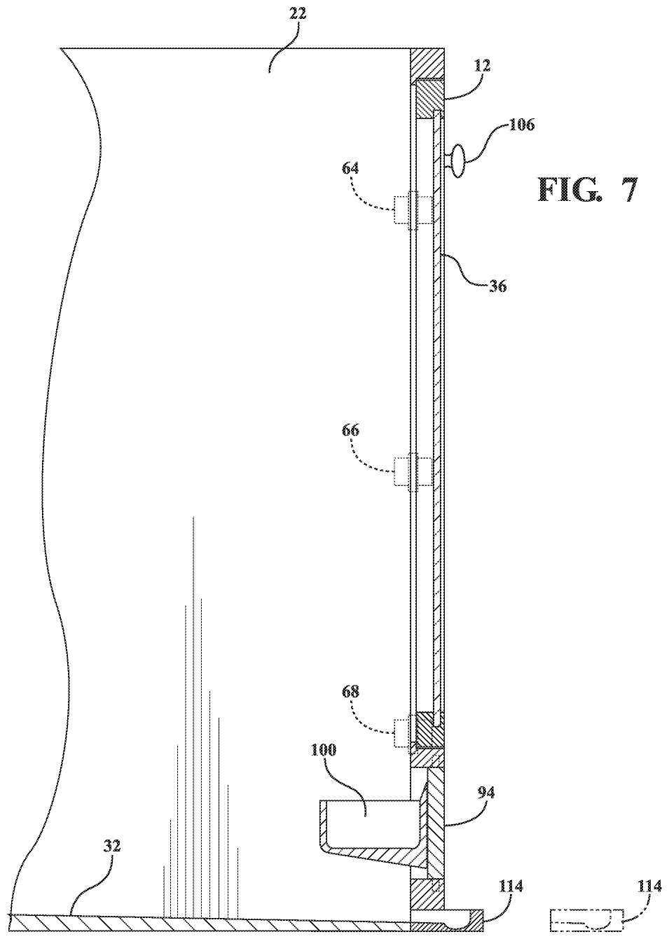

Referring to FIGS. 5 and 7, an associated elongated pan or tray 114 is provided which attaches to a bottom forward edge of the forward door panel 12 and which, in combination with the forward/downward angular tilt of the floor 32 in the downward position, operates to collect liquid waste such as animal urine outside of the enclosure 10. As shown, a slot or channel can be configured within and along bottom proximate edges of the forward panel bottom (see at 116 in FIG. 5) and which permits the pan 114 be slidably installed so that urine travels downwardly/forwardly along the tilted floor 32, through the slotted forward opening 116, and for collecting in a forward concave recessed trap 118 configured in the elongated pan 114.

As further understood, and given the selected overall layout of the unit assembly (including a four foot wide and thirty two foot long variant) a plurality of individual collection trays 114 can be arranged in side by side fashion along the length of the unit and so that the forward collection traps are aligned and interconnected with a waste disposal line (not shown). It is also understood that the forward located urine collection tray is an optional feature and the present invention also envisions other mechanisms for collecting and storing either liquid or solid animal feces, this not limited to the incorporation of other floor designs additional to that shown and described herein.

Having described my invention, other and additional preferred embodiments will become apparent to those skilled in the art to which it pertains, and without deviating from the scope of the appended claims. This can include installing an optional top (not shown) such as with exterior installations. Associated door locks can also include the provision of slide locks which will lock and unlock in the direction of the associated lever. Other features can include designing the panels to inter-act in a fashion to enable a one push opening and closing of the overall assembly and to facilitate the folding action of the respective sides against each other in order to define a minimal footprint in the closed nonuse position.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A collapsible kennel assembly, comprising:
a plurality of individual and pivotally inter-connected panels, a first selected one of said panels adapted to being affixed to the wall, a second selected one of said panels allowing for ingress and egress; and
said panels being inter-collapsed in succession along first and second sides between an expanded use configuration and a folded storage configuration.

2. The assembly of claim 1, further comprising at least one interior subdividing panel hingedly supported relative to a selected panel.

3. The assembly of claim 1, further comprising individual pluralities of hinges inter-connecting each of said panels.

4. The assembly of claim 3, said plurality of panels further comprising a forward door panel having a food and water supporting door compartment at a lower end.

5. The assembly of claim 4, said food and water supporting door being pivotally rotated about a pin to access and inside supporting side thereof.

6. The assembly of claim 1, further comprising a floor panel secured between side panels in order to angle downwardly and forwardly to a front urine collection trap.

7. The assembly of claim 1, said panels each further comprising an injection molded construction.

8. The assembly of claim 3, each of said hinges further comprising hinge components, a circular cross section pin extending from a first hinge component and seating within a recess in the other component for providing swiveling support.

9. The assembly of claim 1, further comprising first and second sub-pluralities of side panels extending between said first and second selected panels.

10. A collapsible kennel assembly, comprising:
a plurality of individual and pivotally inter-connected panels defining an interior enclosure and including each of a rear panel, first and second pluralities of hingedly interconnected side panels, and a front panel hingedly connected to forward most of said first and second pluralities of side panels;
an inner door incorporated into said front panel to allow for ingress and egress in an expanded use configuration; and
said panels being inter-collapsed in succession along first and second sides between an expanded use configuration and a folded storage configuration.

11. The assembly of claim 10, further comprising rearward most of said first and second pluralities of side panels being fixed to said rear panel.

12. The assembly of claim 12, further comprising a bottom panel being hingedly connected along an inside lower edge of said rear panel and so that said bottom panel is upwardly rotated against said rear panel prior to inter-collapsing said side panels.

13. The assembly of claim 12, said bottom panel further comprising a downwardly angled upper surface, a urine collection trap being secured to an exterior bottom edge of said front panel and collecting urine deposited from said bottom panel to an exterior of said enclosure.

14. The assembly of claim 10, further comprising “U” brackets securing along adjoining upper edges of said first and second individual pluralities of side brackets, said “U” brackets being pivoted upwardly prior to said inter-collapsing said panels.

15. The assembly of claim 10, further comprising a pair of interior and enclosure sub-dividing panels hingedly connected to intermediate positioned of said pluralities of side panels, said interior panels being pivoted between open and closed positions to further subdivide the interior enclosure.

16. The assembly of claim 10, said front panel further comprising a rotatably supported food and water supporting door compartment at a lower end for providing exterior refilling and interior rotated positioning within the enclosure.

17. The assembly of claim 10, further comprising a magnetic locking system configured at each hinged interconnection for maintaining the panels in either of the use or storage configurations.

18. The assembly of claim 10, further comprising any of a window or screen incorporated into said inner door of said front panel.

19. The assembly of claim 10, further comprising said rear panel adapted to being affixed to a vertical wall surface.

20. The assembly of claim 10, said panels each further comprising an injection molded construction.
